(19) United States
(12) Patent Application Publication
(10) Pub. No.: US 2024/0254045 A1
(43) Pub. Date: Aug. 1, 2024

(54) 3D-Printable, Self-Reinforced Ultra-Ductile Cementitious Materials

(71) Applicant: UNM Rainforest Innovations, Albuquerque, NM (US)

(72) Inventors: Maryam Hojati, Albuquerque, NM (US); Amir Bakhshi, Albuquerque, NM (US); Muhammad Saeed Zafar, Albuquerque, NM (US)

(73) Assignee: UNM Rainforest Innovations, Albuquerque, NM (US)

(21) Appl. No.: 18/429,262

(22) Filed: Jan. 31, 2024

Related U.S. Application Data
(60) Provisional application No. 63/482,655, filed on Feb. 1, 2023.

(51) Int. Cl. C04B 16/06; B33Y 70/10; C04B 7/02; C04B 14/10; C04B 18/06; C04B 18/08; C04B 18/14; C04B 111/00

(52) U.S. Cl. CPC C04B 16/0641; B33Y 70/10; C04B 7/02; C04B 14/106; C04B 16/0625; C04B 18/067; C04B 18/08; C04B 18/146; C04B 2111/00181

(57) ABSTRACT

A 3D-printable, self-reinforced ultra-ductile cementitious material comprising; a mix of 50 percent cement and 50 percent mineral admixture.

### RELATED APPLICATIONS

This application claims priority to U.S. Provisional Application No. 63/482,655, filed on Feb. 1, 2023, which is incorporated herein in its entirety

### STATEMENT REGARDING FEDERALLY SPONSORED RESEARCH & DEVELOPMENT

This invention was made with government support by the Department of Transportation—The Transportation Consortium of South-Central States grant 69A3551747106. The government has certain rights in the invention.

### INCORPORATION BY REFERENCE OF MATERIAL SUBMITTED ON A COMPACT DISC

Not applicable.

### BACKGROUND OF THE INVENTION

Additive manufacturing (AM) is growing in major industrial countries as the principle of the world economy's future, including the construction sector. AM, also called 3D printing or layer manufacturing, can reduce the carbon footprint by employing recycling methods, innovative organic materials, and proximity of production to consumers by transportation cost reduction. In the construction industry, this novel technology can surpass conventional circumscribes. A wide range of materials has been studied congruously with 3D printing in the different fields of the industry (i.e., aerospace, automotive, and medical), including carbon fiber, metal, acrylonitrile butadiene styrene (ABS), aluminide, nitinol and soil. However, in construction, aggregate-based materials, namely concrete, are the most popular materials for additive construction. So many previous studies employed a material deposition technique with different layers of ordinary Portland cement and sand to achieve a solid freeform fabrication that can be used for large structures.

Despite the vast potential for using 3D printing in construction, some challenges exist in incorporating cementitious materials in 3D printing applications, limiting the broad application of this technology. These challenges include reinforcement, forming cold joints between printed layers which could increase the number of voids and lower the durability, anisotropic mechanical performance, and achieving proper fresh properties of 3D printable mixtures.

### BRIEF SUMMARY OF THE INVENTION

In one embodiment, the embodiments of the present invention address the above-mentioned challenges by providing four ultra-ductile cementitious (UDC) mixes with high strain capacity (up to 11.9%), which are printable with acceptable printing characteristics (i.e., extrudability and buildability) and could be used as a self-reinforced material for the application of 3D printing in the construction industry.

In other aspects, the present invention provides embodiments in which the moment capacity and deflection of UDC can be improved by modifying the mix design, fiber content, and fiber types.

In other embodiments, the present invention includes UDC mixes, such as S50, FA50, FA40-MK10, and FA40-SF10, wherein a half of the cement weight is replaced with mineral admixtures such as slag (S), fly ash (FA), metakaolin (MK), and silica fume (SF).

In other embodiments, the present invention includes UDC mixes specifically designed for mold-cast and extrusion-based 3D printing. PolyVinyl Alcohol (PVA) and Ultra-High Molecular Weight Polyethylene (PE) fibers may be incorporated at different ratios.

In other embodiments, the present invention includes UDC mixes wherein PolyVinyl Alcohol (PVA) and Ultra-High Molecular Weight Polyethylene (PE) fibers incorporated at two different ratios (1.5% and 2% of the total mix volume.

In other embodiments, the present invention includes UDC mixes with 2% PE fibers that have demonstrated ultra-high ductility, achieving a strain capacity of up to 11.9% and tensile strength of 5.85 MPa, with optimized mixing procedures and viscosity modifier admixture.

In other embodiments, the present invention includes mixes with high quality 3D printable UDC with both high compressive strength and ductility.

In other embodiments, the present invention includes UDC mixes wherein 50% of the weight of cement was replaced with FA, S, or combinations of 40FA and 10 MK and 40FA and 10SF.

In other embodiments, the present invention includes a 3D printable UDC mix with ultra-high ductile properties by substituting 50% of cement weights with SCMs and reinforcing it with 8 mm PE fibers.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1. Mixing procedure of UDC Mixtures.

FIG. 2. (1) Raw materials, (2) Mixer and Pump assembly, (3) 3 inches diameter hose, (4) 3D printer frame, (5) Printing nozzle, (6) 2×2 Printing bed, (7) 3D printer processor, (8) PC with software.

FIGS. 3A, 3B and 3C. 3D printed 150×150×60 mm sample with 20 mm circular nozzle (1), four extracted 50×50×50 mm cubic specimens from the primary sample (2), Compressive test setup with samples tested perpendicular to the loading direction (3).

FIGS. 4A, 4B, 4C, 4D, and 4E. (A) Three-point bending schematic test setup, (B) the cross-section of the tested beam, (C) primary 3D Printed slab of 100×350×50 mm with 20 mm circular nozzle, (D) four extracted 140×40×40 mm prism specimens from the primary sample, (E) three-point bending test setup.

FIGS. 5A, 5B, 5C, 5D, 5E, and 5F. Uniaxial direct tensile test schematic test setup (A), dimension of dogbone 3D printed samples (B), 3D printing the specimen inside the molds for under tension area (C), specimen showing 3D printed and cast part (D), test setup (F).

FIGS. 6A and 6B. (1) Compressive strength of specimen containing 1.5% PVA for cast and 3D printed at 28-day age (2) Compressive strength of specimen containing 2% PVA and 2% PE for cast samples at 28-day age.

FIGS. 7A, 7B, 7C, 7D, 7E, 7F, 7G, 7H, 7I, 7J, 7K and 7L. Direct tensile test strain and stress of FA40-SF10 and FA40-MK10 containing 1.5% PVA, 2% PVA and 2% PE at 28 days of age.

FIGS. 8A and 8B. CT scanned images showing the formation of microcracks at dogbone specimens after unloading the applied tension force.

FIGS. 9A, 9B, 9C, 9D, 9E, 9F, 9G, 9H, 9I, 9J, 9K, and 9L. Load-Displacement of UDC printed beams containing 1.5% PVA, 2% PVA and 2% PE at 28 days of age.

FIG. 10. Relation between ultimate load and Mid-span deflection of UDC.

FIGS. 11A and 11B. Post failure of S50 at three-point flexural test (1) flexural diagonal tension collapse and (2) brittle collapse for under-reinforced beams.

FIGS. 12A and 12B. Failure modes of PE fibers.

FIGS. 13A and 13B. Failure mode of PVA fibers.

FIG. 14. Results of flexural tests and failure patterns for different UDC mixes.

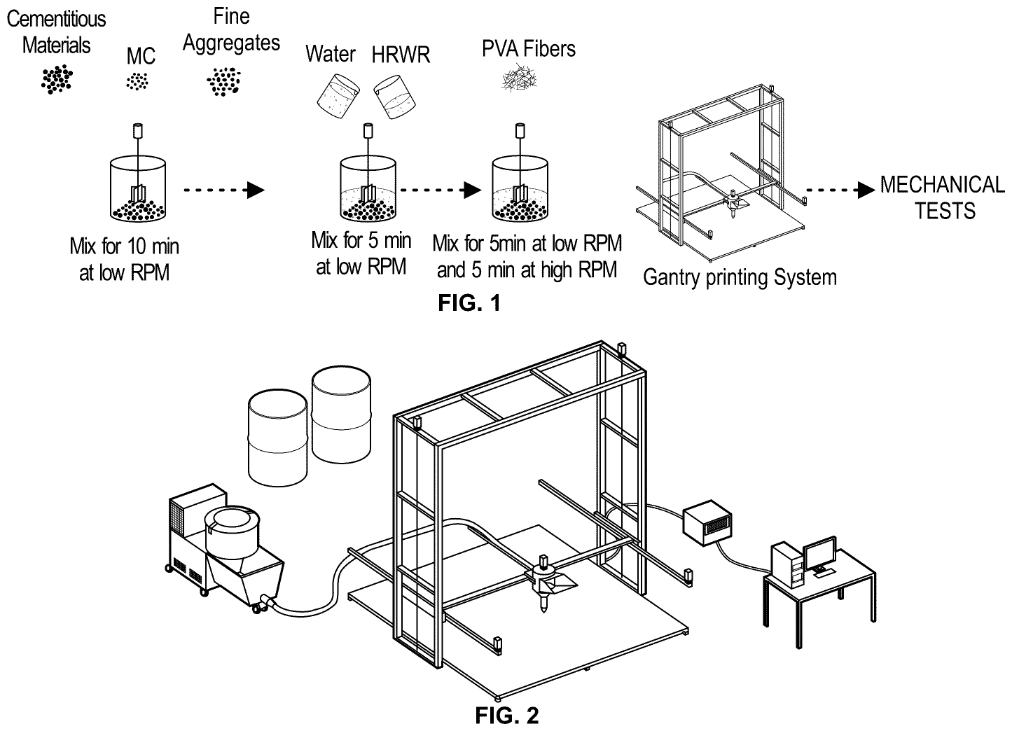

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

### Materials and Mix Designs

Embodiments of the present invention include, but are not limited to, UDC mixes were a combination of 50% type I/II ordinary Portland Cement (C) and 50% mix of other mineral admixtures, including Silica Fume (SF), Class-F Fly Ash (FA), Ground Granulated Blast Furnace Slag (S), and Metakaolin (MK). Table 1 displays the chemical compositions of given mineral admixtures.

UDC mixes were internally reinforced using two types of fibers, non-oil coated RECS15 PVA and ultra-high-molecular-weight PE, and at two volumetric contents (i.e., 1.5% and 2% by the volume of the mixture). The properties of fibers are illustrated in Table 2. From the fiber properties, it is notable that they have a similar length, while PE fibers are 63% thinner than PVA fibers, and the tensile and flexural strengths of PE fibers are 1.9 and 2.5 times, respectively, larger than the strengths of PVA ones.

These UDC mixes contained 25% (by weight) river sand (RS) with a fineness modulus of 2.3 and a maximum particle size of 3.36, which has been used as per ASTM C330. Additionally, the bulk dry specific gravity and absorption capacity of RS were 2.59 and 0.44%, respectively.

The UDC mixtures also include a polycarboxylate-based High Range Water Reducer (HRWR), ADVA 195, supplied by GCP-applied technologies, which complies with the ASTM C494. Additionally, according to our previous research findings, Methylcellulose (MC) was used in the mix designs as a VMA by 0.01 of the binder ratio.

Four UDC mortars were designed, as shown in Table 3. The mixes were named FA50 (representing 50% weight of C replaced with FA), S50 (representing 50% weight of C replaced with S), FA40-SF10 (representing a binder FA50 but with 10% weight of FA replaced with SF), and FA40-MK10 (representing a binder identical to F but with 10% weight of FA replaced with MK).

TABLE 1
Chemical composition of binders

| | | | | | | | | | | Specific |
|---|---|---|---|---|---|---|---|---|---|---|
| Material | SiO₂ | Al₂O₃ | Fe₂O₃ | CaO | MgO | SO₃ | K₂O | TiO₂ | Na₂O | Gravity |
| C | 19.24 | 4.75 | 3.35 | 65.80 | 2.20 | 3.61 | 0.54 | 0.21 | — | 3.13 |
| S | 30.80 | 11.45 | 2.26 | 47.50 | 3.65 | 3.03 | 0.38 | — | 0.17 | 2.91 |
| SF | 97.80 | — | — | — | — | 0.30 | — | — | 0.01 | 2.20 |
| FA | 61.27 | 23.18 | 5.09 | 2.11 | 1.19 | 0.30 | 1.43 | — | 1.44 | 2.09 |
| MK | 53.00 | 43.80 | 0.43 | 0.02 | 0.03 | 0.03 | 0.19 | 1.70 | 0.23 | 2.50 |

TABLE 2
Properties of PVA and PE fibers

| | | | | Tensile | Flexural | |
|---|---|---|---|---|---|---|
| | Diameter | Length | Specific | Strength | Strength | |
| Material | (microns) | (mm) | Gravity | (MPa) | (GPa) | Color |
| PVA Fibers | 38 | 8 | 1.30 | 1600 | 40 | White |
| PE Fibers | 15 | 8 | 0.97 | 3000 | 100 | White |

TABLE 3
Mix proportions of different UDC mixtures

| | Mix | Fiber | | | | | | | Adjusted | | MC | | Fibers |
|---|---|---|---|---|---|---|---|---|---|---|---|---|---|
| # | ID | Type | C/B | FA/B | S/B | SF/B | MK/B | W/B | W/B | RS/B | (%)¹ | HRWR(%)¹ | Vol %)³ |
| 1 | FA50 | PVA 1.5 | 0.50 | 0.50 | 0.00 | 0.00 | 0.00 | 0.27 | 0.23 | 0.25 | 0.01 | 0.006 | 1.50 |
| | | PVA 2 | | | | | | | | | 0.01 | | 2.00 |
| | | PE 2 | | | | | | | | | 0.01 | | 2.00 |
| 2 | S50 | PVA 1.5 | 0.50 | 0.00 | 0.50 | 0.00 | 0.00 | 0.27 | 0.30 | 0.25 | 0.01 | 0.006 | 1.50 |
| | | PVA 2 | | | | | | | | | 0.01 | | 2.00 |
| | | PE 2 | | | | | | | | | 0.01 | | 2.00 |
| 3 | FA40- | PVA 1.5 | 0.50 | 0.40 | 0.00 | 0.10 | 0.00 | 0.27 | 0.27 | 0.25 | 0.01 | 0.006 | 1.50 |
| | SF10 | PVA 2 | | | | | | | | | 0.01 | | 2.00 |
| | | PE 2 | | | | | | | | | 0.01 | | 2.00 |
| 4 | FA40- | PVA 1.5 | 0.50 | 0.40 | 0.00 | 0.00 | 0.10 | 0.27 | 0.27 | 0.25 | 0.01 | 0.006 | 1.50 |
| | MK10 | PVA 2 | | | | | | | | | 0.01 | | 2.00 |
| | | PE 2 | | | | | | | | | 0.01 | | 2.00 |

Note:
¹% HRWR dosage by weight of Binder
2. C: Cement; FA: Fly Ash; S: Slag; MK: Metakaolin; SF: Silica Fume; W: Water; RS: River Sand; B: Binder; HRWR: High Range Water Reducer, MC: Methyl Cellulose
³All ratios are weight (wt) ratios, but the volumetric fiber content.

A gantry 3D printer system was used to create the samples for mechanical testing, as displayed in FIG. 2. The gantry system can move in the three principal axes in a straight line.

The maximum reach of the system is 2×2×2 m. In addition, the system is equipped with a hopper above the nozzle to adjust the extrusion speed and ensure the consistency of the filament while printing. The hopper is mounted to a one-stage pump-mixer by a 50 mm diameter circular hose that allows for mixing fresh materials in a batch and pumping. The nozzle size is adjustable, but for the produced samples, a 20 mm diameter circular shape nozzle has been used to increase the accuracy of printed objects. The extrusion speed of the hopper can reach up to 50RPM, and the maximum printing speed can reach up to 50 mm/s. The tool paths produced for the 3D printer are in G-code format, and simplify 3d software has been used as slicing software to produce the desired geometries.

### Compressive Strength of Cast Samples

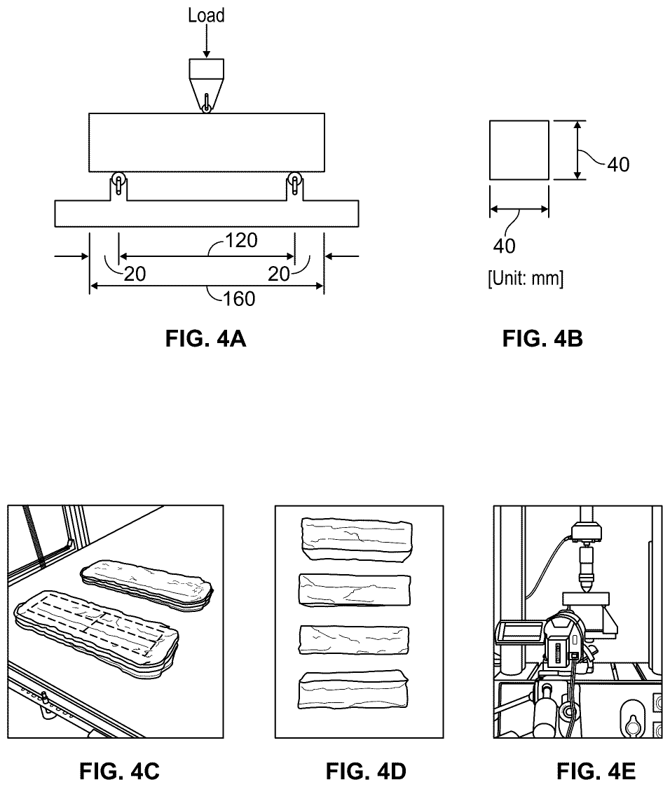

The compressive strength of cast samples made of 1.5% PVA, 2% PVA and 2% PE was evaluated to ensure the viability of using the designed UDC for structural applications. Three cubic samples of 50×50×50 mm were prepared according to ASTM C109-20. The cast cubes were demolded after 24 hours and placed in a controlled moisture room (100% RH, 23±0.5° C.) 24 hours after preparation and kept for 28 days to perform the compressive test. A Forney compression testing machine with a maximum capacity of 400 kips and a ramp rate of 100 psi/s, as shown in FIG. 4 (3), was used to obtain the test results.

### Compressive Strength of 3D Printed Samples

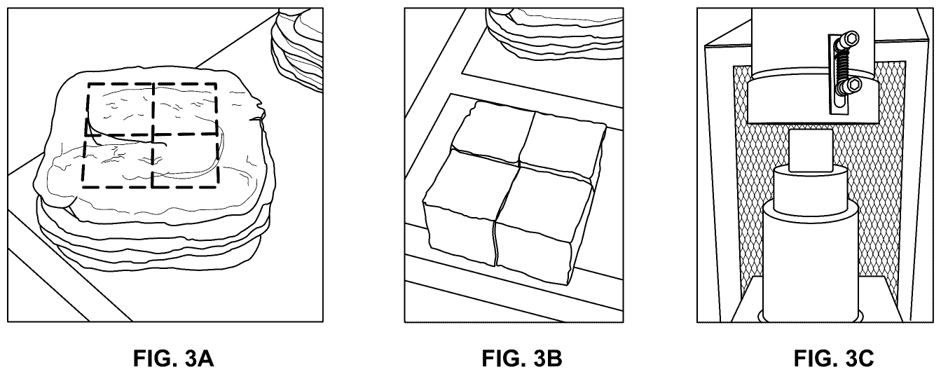

The impact of 3D printing on compressive strength was examined by subjecting mixtures containing 1.5% PVA fibers to compressive loads, as depicted in FIG. 3. Initially, a prism sample was printed for each mixture, comprising six layers with dimensions of 150×150 mm and an overall height of 60 mm. These samples were 3D printed utilizing the gantry system, employing a nozzle with a diameter of 20 mm. To be consistent with cast samples, the prisms were transferred to a controlled moist room (100% RH, 23±0.5° C.) after 24 hours and kept there until the testing day. Before testing, four small cubes of 50×50×50 mm were extracted from the preliminary prism using a wet saw. All samples were tested perpendicular to the printing direction. The cubes were tested after 28 days at a loading rate of 100 Psi/s according to ASTM C109-20.

### Flexural Strength of 3D Printed Samples

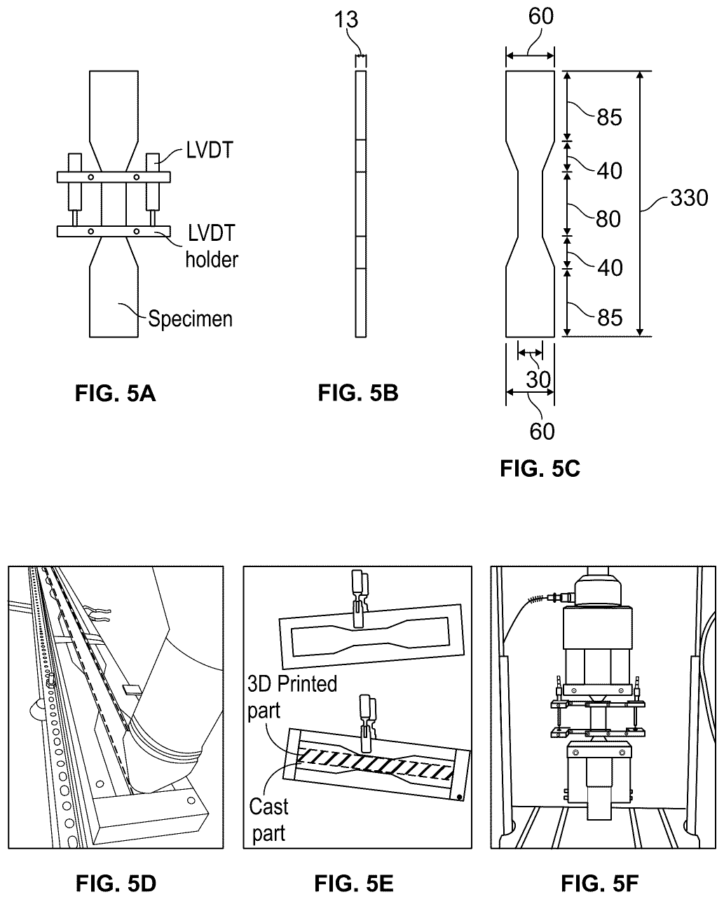

A three-point flexural test was conducted according to the ASTM C 348-02 to evaluate the flexural strength of different mixes; FIG. 5 illustrates the test setup and samples. A prism of 100×350×50 mm was 3D printed initially, using a 20 mm diameter nozzle. The samples were placed in a moist room (100% RH, 23±0.5° C.) after 24 hours and kept there until the testing day. Before testing, four prisms of 40×40×160 mm were extracted from the primary 3D printed prism. An Instron Universal testing machine with an applied load of 0.5 mm/min was used to test the specimen, and the mounted LVDT to the setup measured the deflection of samples illustrated in FIG. 4.

### Uniaxial Direct Tensile Test

The dogbone samples' dimensions and thickness were according to the Japan Society of Civil Engineers (JSCE) recommendation FIG. 5 illustrates the test setup and the dimensions of the samples prepared for the direct tensile test. The fiber orientation can impact the mechanical properties of the test specimens. Therefore, all samples were 3D printed using a 30 mm diameter nozzle to achieve the desired fiber orientation. Cutting dogbone shape samples from a prism as a standard method for obtaining samples would be challenging with a lack of equipment, so a different approach was adopted. The specimen's cross-section measures 30×13 mm when subjected to tensile load. In the case of printed UDC, a 30 mm wide filament was 3D printed within the mold, while the remaining void spaces of the molds were filled with cast UDC to create the dogbone-shaped samples. The printed specimens were prepared and kept in a moisture room (100% RH, 23±0.5° C.) for 28 days. The uniaxial direct tensile test was performed using an MTS Bionix servo-hydraulic universal testing machine (shown in FIG. 5 (5)) with an applied load of 0.5 mm/min, according to JSCE. Two external linear variable displacement transducers (LVDTs) were fixed to a rigid plastic frame to measure elongation. The average value of two LVDTs was considered to calculate the tensile strain.

### Micro Imaging and Scanning of Cracked Samples

Scanning Electron Microscopy (SEM) and CT scan images were acquired to gain deeper insights into the crack propagation of failed samples and the crack patterns of failed fibers during direct tension and bending tests. The SEM analysis was carried out utilizing the JEOL 5800LV SEM equipped with the secondary and backscattered electron and cathodoluminescence (CL) imaging detectors at the Institute of Meteoritics, University of New Mexico. The broken prisms from the flexural strength test were used for SEM analysis to detect the fiber failure types. Similarly, for CT Scan Imaging, the North Star Imaging (NSI) 225kVa CT scanner at the Center for Advanced Manufacturing at Navajo Technical University was used. X-ray CT scans were taken for the failed dog bone specimens and prisms.

### Results and Discussion

### Compressive Test Results

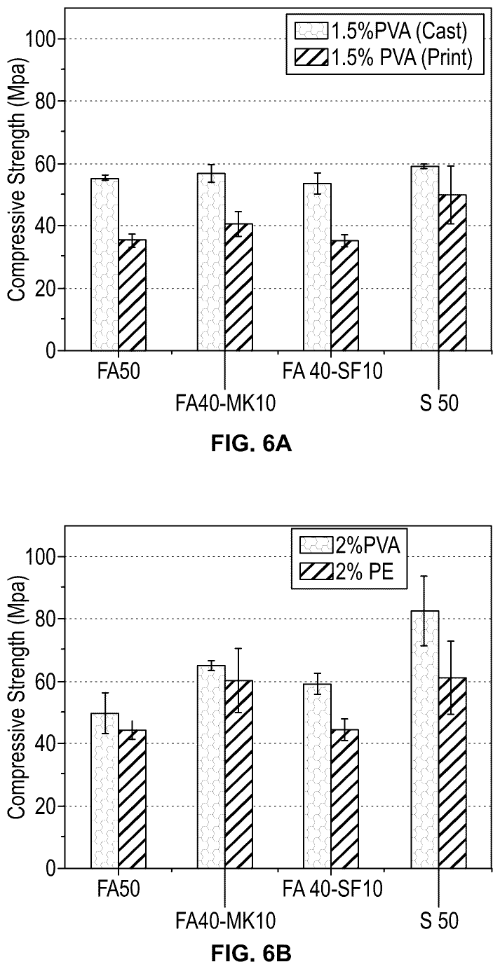

The compressive strength development of cubic samples after 28 days of age is illustrated in FIG. 6. Each data point averages the results of three and four specimens for the cast and 3D-printed ones, respectively, and compares the results of cast versus (vs.) 3D printed specimens, different UDC mixes made of various SCMs, different PVA fiber content, and types of fibers (2% of PVA vs. PE).

The results of UDC mixes containing 1.5% PVA fibers are presented for both cast and 3D printed specimens to evaluate the effect of 3D printing on the mechanical properties of the developed specimens (FIG. 6 (1)) Overall, the compressive strength of the 3D printed cubes was lower compared to the cast ones. According to FIG. 6 (1), using 1.5% PVA fibers, the compressive strength of the cast specimens was in the 53.5-59.0 MPa range, while for the 3D-printed cubes, this strength range was dropped to 35.15-50.0 MPa. FA50-1.5PVA exhibited the max compressive strength reduction of 36% for cast vs. 3D-printed specimens. The compressive strength of cast FA40-MK10-1.5% PVA, FA40-SF10-1.5% PVA, and S50-1.5% PVA decreased for the 3D-printed samples by 28%, 34%, and 15%, respectively. This compressive strength reduction could be attributed to forming voids between extruded filaments (i.e., inter-filament voids). These voids in the printed structures act as defects and adversely influence the hardened properties of the 3D-printed specimens. Furthermore, curing the specimens within the first day after making them can potentially alter the material's strength in later stages. As the cast specimens remained in the mold for the initial day after casting, they experienced less exposure to drying when compared to the 3D printed prisms, which had all surfaces exposed to drying. The reduction in the compressive strength of 3D-printed materials appears to be the result of the introduced air voids between two adjacent layers by the extrusion-based 3D printing process, which might weaken the load-bearing capacity of UDC to some extent. Generally, printed layered structures are presumed to be anisotropic due to forming voids between the filaments and between layers. As a result, a weak bond between the layers or void presence along the printing direction due to the poorly executed printing process can weaken the compressive strength of printed objects depending on the applied load direction.

FIGS. 6 (1) and (2) shows the effect of using different SCMs (i.e., F, MK, SF, and S) in the mix design of UDC on compressive strength development. From FIG. 6 (1), in 1.5% of PVA fibers, the maximum strength of 3D-printed cubes was observed for S50 (i.e., 50.0 MPa), while the minimum strength was reported for FA50 (i.e., 35.15 MPa; and in overall, the lower compressive strength was associated with the FA-rich mixes (i.e., FA50, FA40-MK10, and FA40-SF10), while S50 showed the maximum compressive strength in all 1.5% PVA and 2% of PVA and PE fibers cases. The higher strength observed in S50 could be attributed to slag particles containing a substantial calcium oxide content. This could lead to accelerated setting times and greater precipitation of calcium-silicate-hydrate (C-S-H) in the early stages, consequently enhancing the compressive strength of mixtures rich in slag. Replacing FA with MK or SF led to larger compressive strength and, at 2% PVA, improved the compressive strength of FA50 by 10% and 14% for FA40-MK10 and FA40-SF10, respectively. This indicates that MK and SF incorporation would improve the compressive strength of UDC mixes after 28 days, regardless of having a higher W/B ratio than FA50. Including SF and MK would densify the mix and overall compactness with refinement of pore structure, resulting in higher compressive strength. MK is also a pozzolanic material rich in alumino silicate source materials. The reaction between Al₂O₃ and SiO₂ from MK and CH generated during hydration could enhance the amount of C-S-H gel in the matrix, increasing compressive strength. FIG. 6 displays the results of four UDC mixes at 1.5 and 2% fiber content.

Increasing the PVA fiber quantity from 1.5% to 2% improves the compressive strength of UDC in all cases except FA50, which was reduced by 10%. The positive aspect (as observed for S50, FA40-MK10 and FA40-SF10) is that it can enhance compressive strength by constraining lateral expansion during loading through fiber bridging, resulting in microcrack sliding and extension. Conversely, increasing fiber content raises UDC's porosity and density, ultimately reducing strength. Nevertheless, the inclusion of MC enhanced the consistency of UDC with 2% fibers in its fresh state and resulted in denser materials in later stages of curing for all formulated UDC mixes, except for FA50.

FIG. 6 (2) demonstrates the compressive strength of cast UDC mixes containing 2% PVA vs. 2% PE fibers to assess the effect of fiber type on the compressive strength of UDC mixtures after 28 days. Replacing PVA with PE in mixes containing 2% fibers reduces compressive strength in all cases. The compressive strength of UDC mixes with 2% PVA fibers was in the range of 49.6-82.5 MPa, while this strength range decreased to 42-60 MPa for the incorporation of 2% PE fibers. The maximum strength reduction by utilizing different types of fibers was for S50, and its strength was reduced by 26% after replacing PVA fibers with PE ones. This lower compressive strength for PE fiber could be explained by the physical properties of PE fibers shown in Table 2. The diameter of PE fibers is ⅓ that of PVA fibers, resulting in a greater quantity of fibers with the same weight. As a result, the decrease in compressive strength in PE mixes compared to PVA can be ascribed to the higher quantity of PE fibers in UDC mixes, which renders the PE mixes more susceptible to increased porosity and a subsequent reduction in strength.

The results from the compressive strength test prove that a higher compressive strength with a higher fiber content is achievable by adopting appropriate approaches to improve fiber distribution. The fact that the compressive strength improved with increasing fiber contents demonstrates the performance of the adopted approach. Introducing a viscosity modifying agent (MC) and adjusting the mixing procedure was the adopted approach to achieve the desired fiber distribution, leading to better mechanical performance. The higher standard deviation of specimens containing 2% fibers can be attributed to the inhomogeneous distribution of fibers, which tends to appear more with higher fiber contents. Including slag in fiber-reinforced concrete can enhance fiber dispersion, thereby improving the mechanical performance of UDC. This is because the slag particles contribute to the fibers' mortar matrix flow and dispersion. In addition, the fact that S50-2% PVA had the highest compressive strength with 82.47 MPa proves that slag particles can improve fiber distribution and UDC's compressive strength.

### Direct Tensile Test

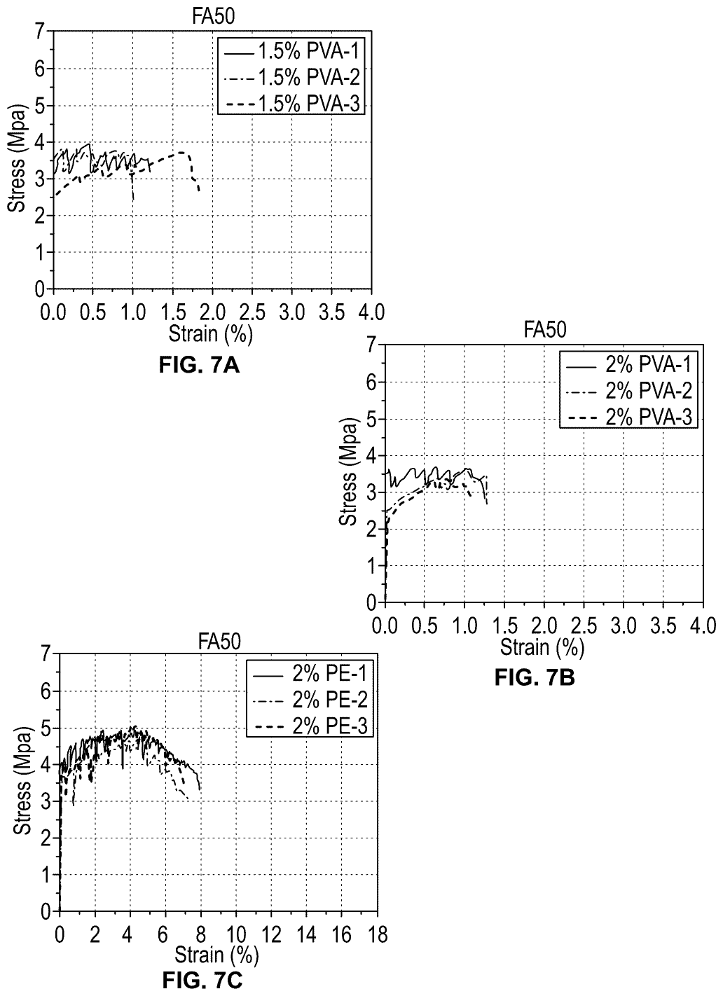

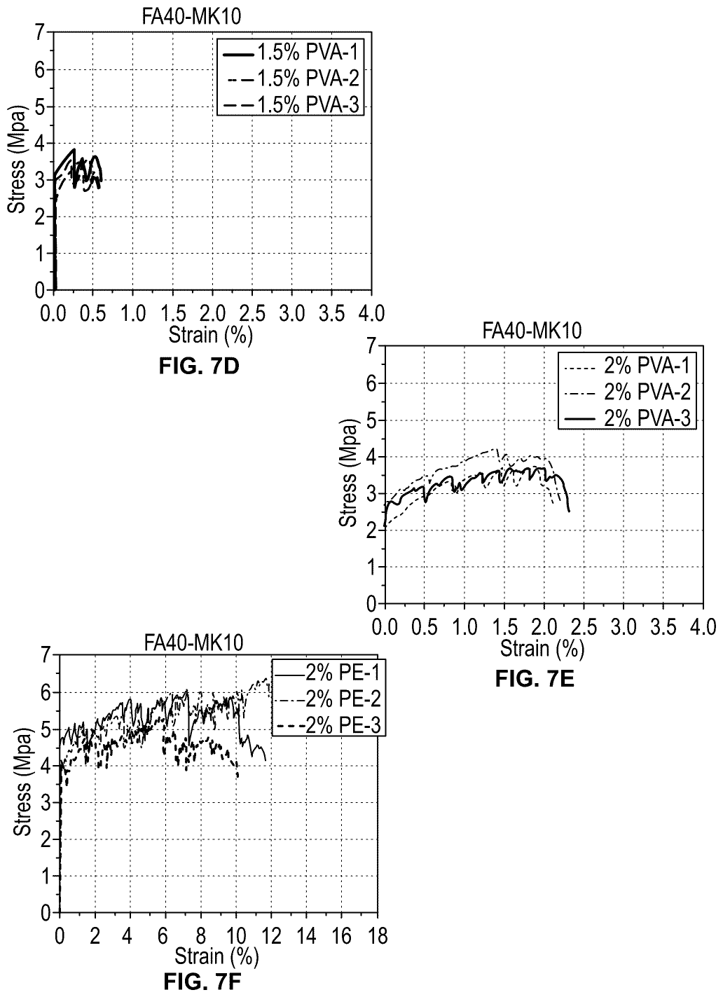

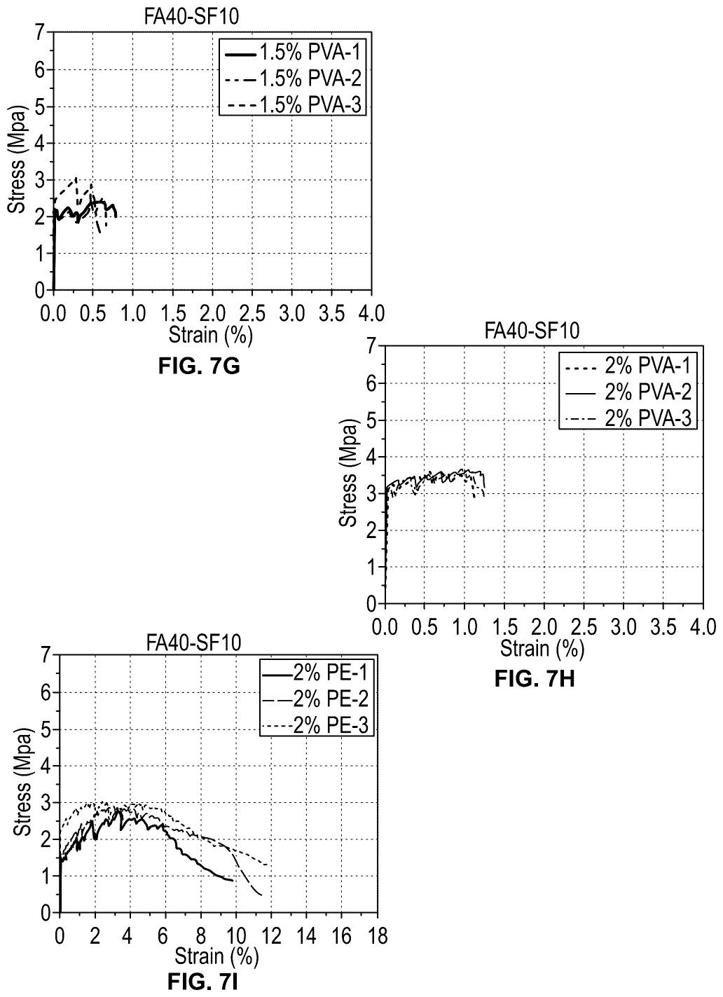

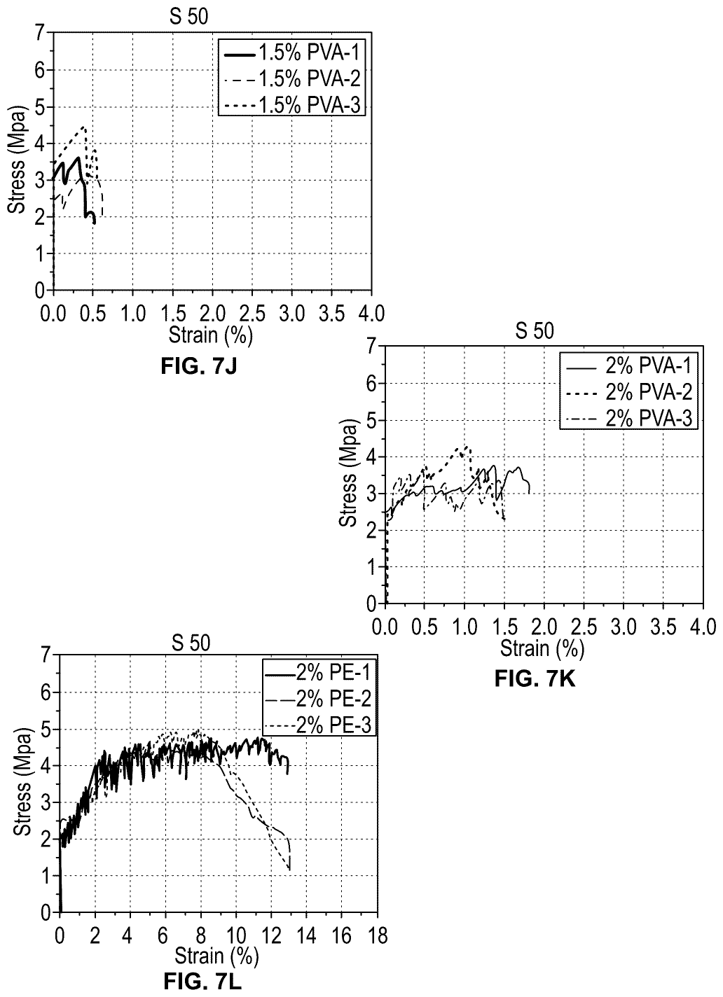

FIG. 7 presents the stress-strain curve from direct tensile tests of 3D-printed dogbone specimens at 28-day age and examines the effects of the UDC mix design, fiber content (1.5% vs. 2% PVA fibers), and fiber types (2% PVA vs. 2% PE fibers). There were three repeats for each mix, and as shown, the results of the three tensile tests were in good agreement for all UDC mixes. Overall, the tensile stress-strain curve of all UDC mixes exhibits two regions, including the linear elastic region at the beginning of the curve, followed by the plastic portion of the curve, which is a strain-hardening region. Notably, all the specimens exhibited pseudo-strain hardening behavior and multiple cracking. Additionally, the numerical results of tensile properties of all UDC specimens after 28 days under the uniaxial direct tensile test are illustrated in Table 4. Tensile properties of UDC mixes after 28 days under uniaxial direct tensile test. Moreover, from stress-strain curves, the yield stress and strain energy densities were computed as an approximate area under the stress-strain curve before yielding and after rupture and represented as the modulus of resilience and toughness, respectively, in Table 4. Toughness is the material properties that indicate the material's ability to resist plastic deformation up to rupture, and it is a good balance of ultimate strength and strain capacity (i.e., elongation or ductility).

The fibers bridge microcracks that form within the UDC mixes under tensile loads. This bridging effect helps to distribute stress across the crack and prevents it from propagating further. Therefore, as it was expected, increasing the PVA fiber contents from 1.5% to 2% enhances the strain capacity of all UDC mixes. FA50 exhibited minor change (i.e., 1.14% increase) in strain capacity, while FA40-MK10 showed maximum change (i.e., 317% increase). However, including additional PVA fibers led to an enhancement in ultimate tensile strength for all UDC types except FA50. This observation aligns with the findings from the compressive strength results depicted in FIG. 6. Notably, FA50 exhibited a decrease in strength with the increasing presence of PVA fibers. This phenomenon may be attributed to the formation of air voids, which occurred due to the higher fiber content. Moreover, increasing the PVA content from 1.5% to 2% had a positive impact on ductility, enabling the material to deform further before reaching failure. Consequently, this enhancement facilitated greater energy absorption and larger deformations. Consequently, augmenting the fiber content contributed to the improved toughness of UDC mixes, with the exception of FA50, as illustrated in Table 4. Increasing the fiber content from 1.5% to 2%, for all mixes but SF reduces the first crack strength which is in good agreement with other studies.

The stress-strain results of different UDC mixes in FIGS. 7 and Table 4 indicate by utilizing 2% PVA fibers with various SCMs, the highest ultimate tensile strength was identified in S50 (4.03 MPa), while the lowest was observed in FA50 (3.51 MPa). Incorporating MK and SF into FA mixes resulted in matrix densification and an enhancement of its tensile strength at 2% PVA, which all agreed with the compressive strength results. Regarding strain capacity, all UDC mixes with PVA fibers displayed less than 5% elongation, and therefore, they cannot be categorized as ductile materials. Among 2% PVA mixes, FA40-MK10 exhibited the largest elongation (2.11%) and toughness (0.12 MPa).

In general, the typical length of PVA fibers utilized for UDC is 12 mm, whereas the PVA fibers used in this study are 8 mm. Comparing the stress-strain curve of other studies related to PVA fiber-reinforced UDC revealed that 8 mm PVA fibers were unsuitable for achieving the desired strain capacity and optimum fiber bridging.

Replacing 2% PVA fibers with PE fibers significantly enhanced the strain capacity of UDC mixes, resulting in a substantial increase ranging from 310% to 752% and an ultra-ductile fiber-reinforced composite. This elevated the elongation of the materials beyond 5%, classifying them as ductile materials, as detailed in Table 4. The stress-strain curves of the specimens containing 2% PE have more fluctuation under tension, and the development of fiber bridging and strain hardening is more evident than in 1.5% PVA and 2% PVA mixes. Apart from enhancing strain capacity, the replacement of PVA with PE also boosted the ultimate tensile strength in all UDC mixes except for FA40-SF10. Excellent toughness results from the synergy of outstanding ultimate tensile strength and ductility. For all the UDCs, substituting PVA with PE led to an improvement in their toughness, ranging from 343% to 767%. These observations are closely linked to the reported mechanical properties of PE fibers, which are presented in Table 2. The tensile strength capacity of PE fibers is approximately 1.9 times greater than PVA fibers.

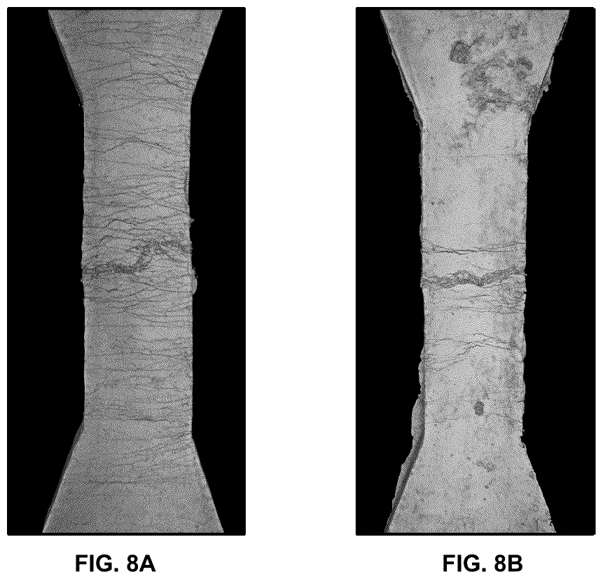

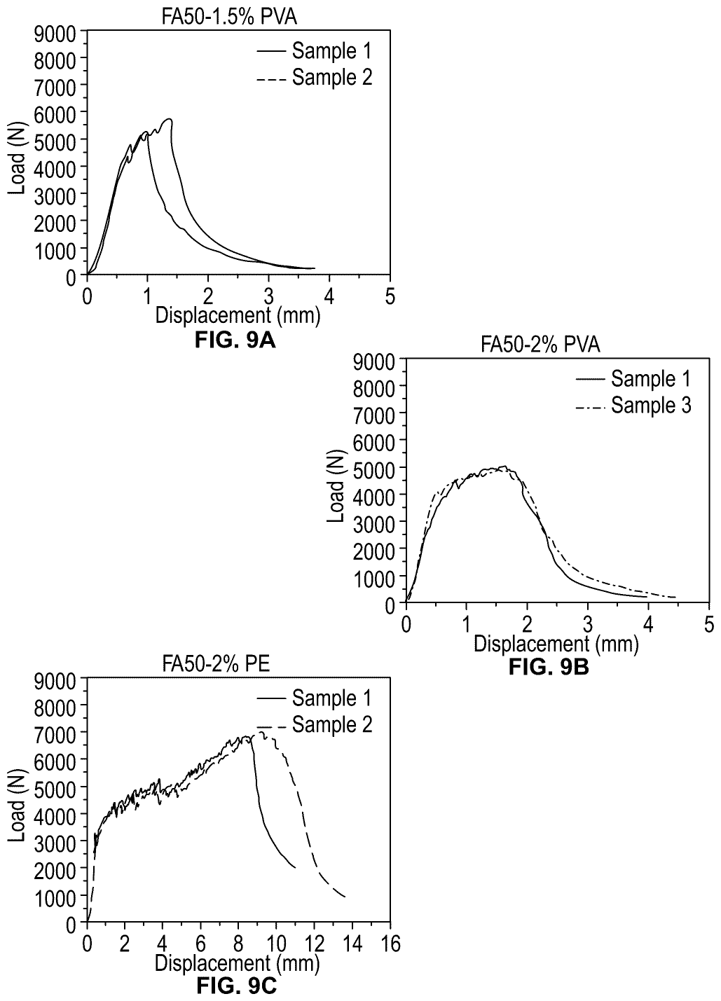

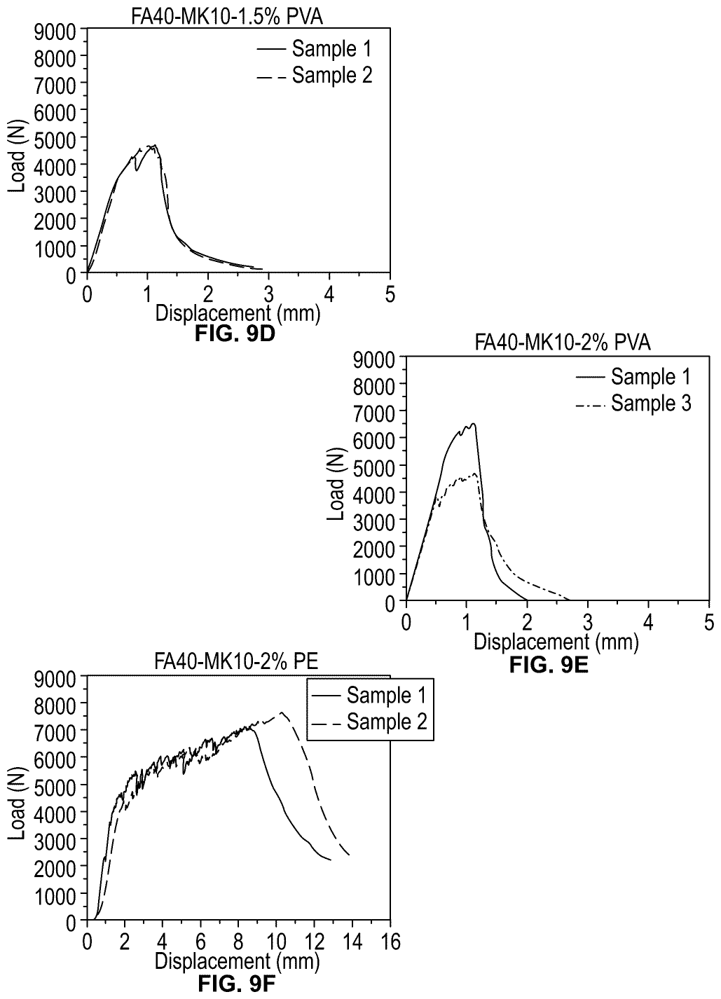

Consequently, PE fibers offer superior microcrack bridging performance within the UDC matrices, as displayed in FIG. 8. UDC has an ability to develop fine and closely spaced microcracks when subjected to tensile stresses. These microcracks are usually very small and not visible to the naked eye after unloading the samples. However, according to the unloaded images of these PE samples in FIGS. 8, the size of the microcracks width was relatively large compared to what was reported in the previous UDC literature (i.e., below 100. μm [51][35]), which likely contributed to the high strain capacity of this material. As illustrated in FIG. 8, most of those cracks remain relatively wide even at an unloaded state and visible with the naked eye, which suggests a significant amount of fiber slippage relative to the matrix.

For the mixes developed by 2% PE fibers, the stress-strain results of different UDC mixes, as shown in FIGS. 7, indicate the highest ductility of S50 compared to other UDC mixes. For 2% PE fiber, the strain capacity of S50 is 1.4 times larger than FA50. In comparison, the ultimate tensile strength of FA50 specimens was 3.8% larger than that of S50. As such, the modulus of the toughness of S50 is 15% larger than FA50%. This observation implies that adding slag would enhance UDC's bridging capacity and energy absorption. Additionally, substituting 10% of MK with FA in FA50 resulted in almost similar ultimate tensile strength, as reported in Table 4, while replacing FA with SF led to lower tensile strength.

The first cracking strength corresponds to the load at which the stress-strain curve deviates from linearity, and the first cracking initiates. The first cracking strength defines at which the load-deflection characteristics depart from linear behavior, and crack formation initiates from the weakest segment within the matrix. The first cracking strength in 2% PE, S50, and FA40-SF10 is 20% and 80% lower than corresponding mixes with 2% PVA fibers. The toughness of 2% PE mixes surpasses that of 2% PVA in all UDCs. Substituting PVA fiber types with PE enhanced the toughness of all mixes by more than sixfold, except for FA40-SF10, which showed a 4.4-fold increase due to the lower initial cracking strength of the SF-rich mix.

The embodiments of the present invention exhibit 11.87% strain capacity and 4.73 MPa tensile strength in the S50-2% PE mix offering a substantial enhancement in both strain capacity and tensile strength.

TABLE 4
Tensile properties of UDC mixes after 28 days under uniaxial direct tensile test

| | Fiber type | First cracking | Ultimate tensile | Strain | Toughness |
|---|---|---|---|---|---|
| Mix ID | and content | strength (MPa) | strength (MPa) | Capacity (%) | (MPa) |
| FA50 | PVA 1.5 | 3.13 (±0.50) | 3.82 (±0.10) | 1.07 (±0.10) | 0.06 (±0.01) |
| | PVA 2 | 2.71 (±0.59) | 3.51 (±0.13) | 1.18 (±0.08) | 0.06 (±0.01) |
| | PE 2 | 3.68 (±0.01) | 4.94 (±0.06) | 7.35 (±0.68) | 0.52 (±0.04) |
| FA40- | PVA 1.5 | 2.93 (±0.13) | 3.76 (±0.15) | 0.55 (±0.02) | 0.03 (±0.00) |
| MK10 | PVA 2 | 2.39 (±0.24) | 3.88 (±0.26) | 2.11 (±0.05) | 0.12 (±0.01) |
| | PE 2 | 3.99 (±0.43) | 5.85 (±0.42) | 8.67 (±0.86) | 0.61 (±0.08) |
| FA40- | PVA 1.5 | 2.05 (±0.14) | 2.62 (±0.36) | 0.64 (±0.10) | 0.02 (±0.00) |
| SF10 | PVA 2 | 3.17 (±0.08) | 3.61 (±0.04) | 1.14 (±0.07) | 0.07 (±0.01) |
| | PE 2 | 1.76 (±0.46) | 2.95 (±0.28) | 9.71 (±1.08) | 0.31 (±0.04) |
| S50 | PVA 1.5 | 2.95 (±0.45) | 3.77 (±0.54) | 0.53 (±0.04) | 0.03 (±0.01) |
| | PVA 2 | 2.59 (±0.10) | 4.03 (±0.27) | 1.54 (±0.26) | 0.09 (±0.02) |
| | PE 2 | 2.16 (±0.31) | 4.73 (±0.15) | 11.9 (±1.39) | 0.60 (±0.09) |

*Note:
The values in parentheses indicate the standard deviation of three measurements

For each mix, two tests were conducted to check the reliability of the measurement. These plots present the role of UDC mix design, the PVA fiber content (i.e., 1.5% vs. 2%), and fiber types (i.e., PVA vs. PE) on the flexural behavior of 3D-printed beams. Table 5 displays the moment capacity of each beam and the observed crack pattern. The moment capacity of each beam was calculated according to the following equation (Eq.1), developed for a 3-point bending test of a simply supported beam with a point load at the mid-span of the beam:

$${M}_{n} = \frac{PL}{4} \qquad ( Eq . 1 )$$

$$where : {M}_{n} = moment capacity ( KN \cdot m )$$

$$P = load at the fracture point ( KN )$$

$$L = length between supports ( m )$$

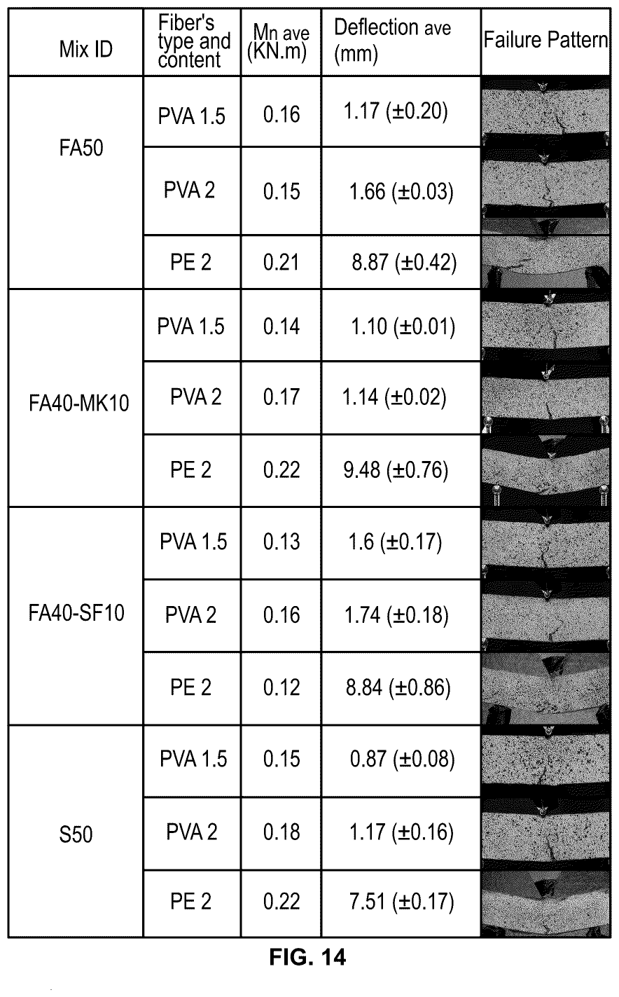

FIG. 14 illustrates the moment capacity and deflection of all UDC mixes. S50 had the highest, and FA40-SF10 exhibited the lowest moment capacity at different fiber types/contents among the four primary mixes. Substituting 10% of MK with FA in FA50 resulted in a nearly similar moment capacity, as reported in Table 8, while replacing FA with SF led to lower moment capacity and resistance to bending.

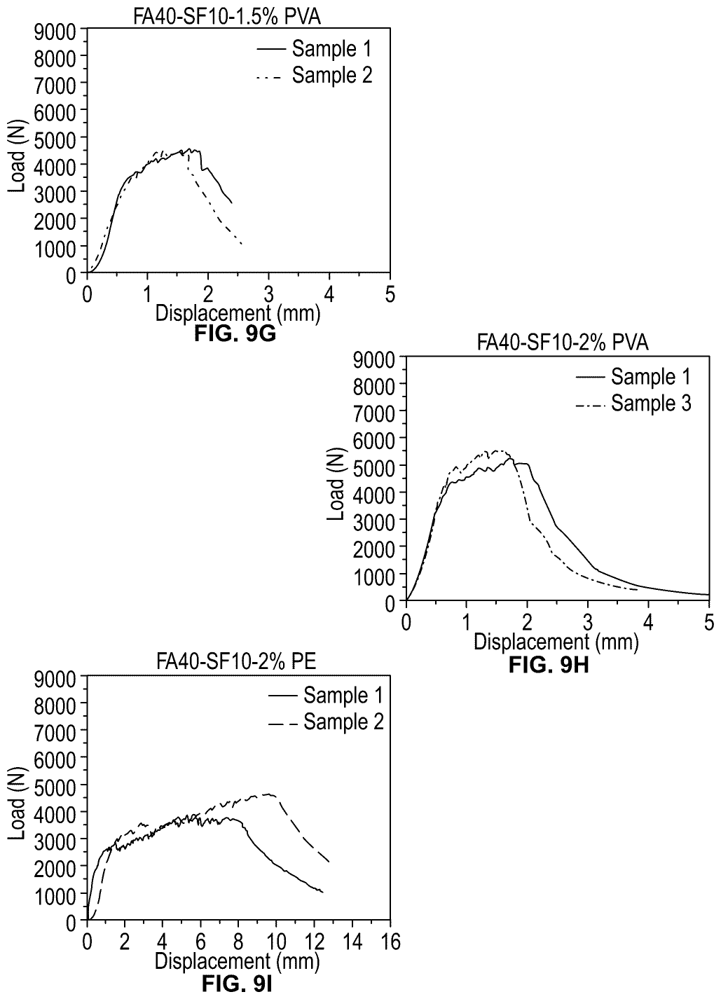

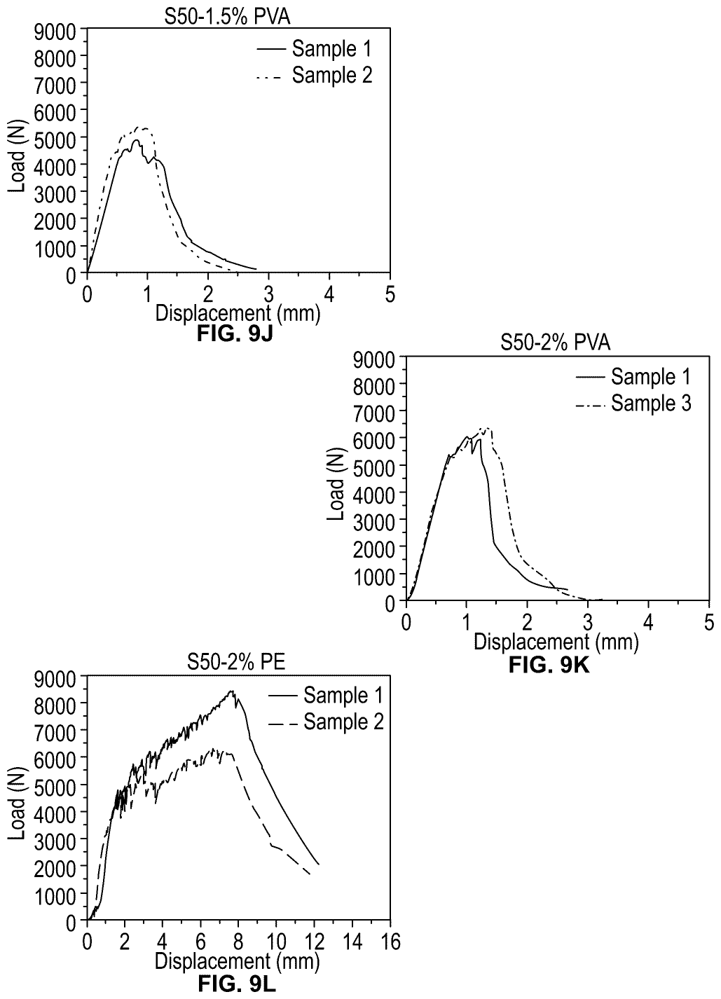

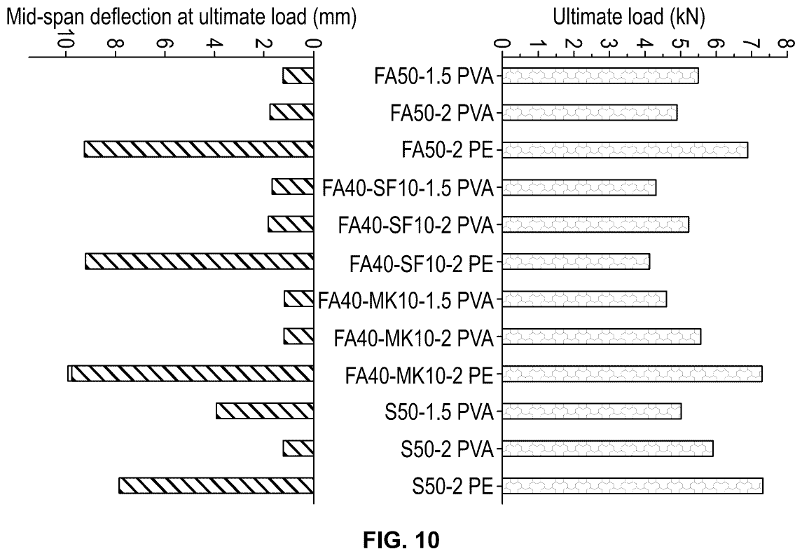

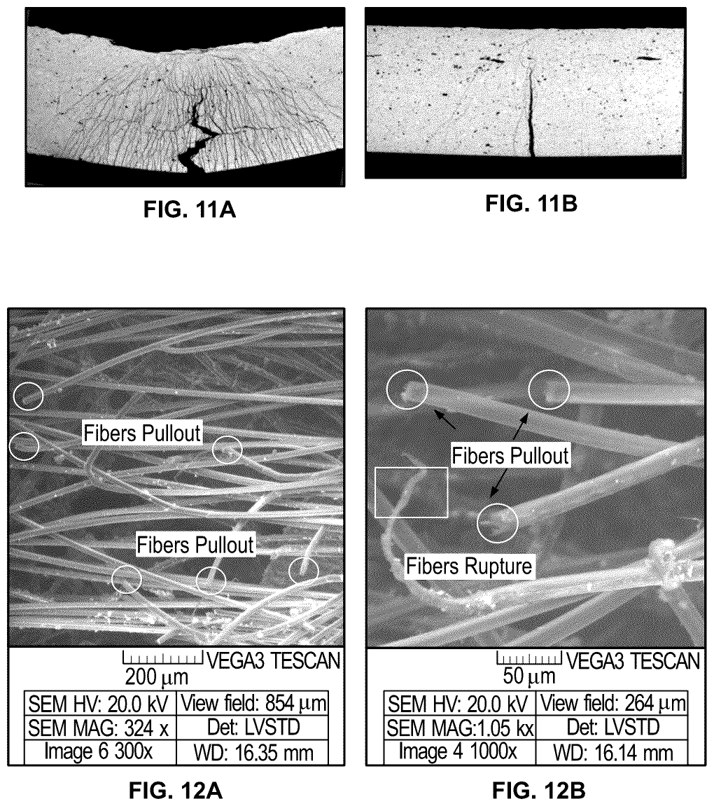

Increasing PVA fiber content from 1.5% to 2% enhanced all UDC specimens' moment capacity and deflection, except FA50, as indicated in Table 5. These findings align with the ultimate tensile strength results mentioned earlier. It's worth noting that in the case of FA50, increasing the fiber content from 1.5% to 2% also led to a reduction in tensile strength, as indicated before and accordingly, it can reduce the moment capacity of this mix. Nevertheless, mixes developed by substituting 10% of FA with MK or SF exhibited an altered trend and as expected, the introduction of additional fibers enhanced their moment capacity and deflection. FA40-MK10 and FA40-SF10 showed the most enhancements in moment capacity, boasting a remarkable 21% and 23% increase, respectively, compared to the other two mixtures. According to FIGS. 9, Table 5 and FIG. 11, the flexural vertical cracks formed at or near the midspan for mixes containing PVA fibers and propagated rapidly and without warning. As the cracks extend and merge, they lead to sudden and brittle beam failure, where the maximum deflections range from 1 to 2 mm. The failure pattern of UDC reinforced with PVA fibers, as depicted in FIGS. 11, closely resembles the failure pattern observed in under-reinforced concrete beams. Therefore, crack bridging was not effectively facilitated even with a 2% of 8 mm PVA fibers. The load-displacement curve indicates limited oscillation related to crack bridging for these fibers, which agrees with the stress-strain curves in FIG. 7.

Replacing 2% 8 mm-PVA fibers with 2% 8 mm-PE fibers significantly improved flexibility, effectively transforming the UDC beams into ultra-flexible beams, as summarized in Table 5. Specifically, UDC samples with PVA fibers exhibited 1-2 mm deflections. In contrast, specimens containing PE fibers demonstrated deflections between 8-10 mm, representing a remarkable 311-752% increase in deflection capacity. FIG. 9 indicated that the UDC mixes reinforced with 1.5% and 2% PVA fibers exhibit none or negligible pseudo-strain hardening characteristics, while 2% PE UDC samples exhibit pseudo-strain hardening behavior under flexural load as expected from their stress-strain curves in FIG. 7. As shown in Table 5 and FIGS. 11, the beams reinforced with PE fibers exhibited a combination of vertical flexural cracks and diagonal shear cracks, a pattern closely resembling that observed in beams reinforced with steel rebars. The PE fibers bridge the cracks and exhibit unique properties of UDC corresponding to their strain-hardening behavior, which means that as the material stretches under load, microcracks form and propagate but do not lead to brittle failure. Instead, the material continues to carry load even as these microcracks develop, contributing to its exceptional ductility and toughness, as observed in FIG. 7.

The considerable gap between the deflection of PE and PVA samples can be attributed to the physical and mechanical differences among these fibers. It should be noted that the fiber failure mode and fiber status can significantly affect the strain capacity of UDC. When stress exceeds the fiber strength, the rupture occurs, whereas pullout occurs when the short side of fibers is pulled out of the matrix. One parameter that significantly affects the failure mode is fiber length. As the fiber length increases, the embedded length of fibers inside the matrix increases, resulting in a larger interfacial frictional force acting on the fibers. In other words, the increase in the length of fibers leads to higher interfacial friction between the fibers and matrix and ultimately results in a higher percentage of ruptured fibers.

As explained before, the diameter of PVA fibers is around 38 microns, whereas the diameter of PE fibers is around 15 microns. Indicating that in an equal weight of fibers, the PE fibers would have two times more surface area than PVA fibers to interact with the matrix, and ultimately, the interfacial friction between the fibers and matrix would be two times higher than PVA fibers with a controlled crack width opening.

Comparing the deflection of different mixes reinforced with 2% PE fiber, FA50 exhibited similar deflection to FA40-MK10 and 18% and 7% higher deflection than S50 and FA40-SF10, respectively. Besides deflection, the moment capacity of all UDC mixes reinforced with 2% PE fiber, except FA50-SF10, improved compared to the ones reinforced with 2% PVA fiber. Table 5 demonstrates that FA50 with 2% PE fibers exhibits a 40% higher moment capacity than the equivalent mix with 2% PVA. However, for the FA40-SF10 mix, despite the improvement in deflection by switching from 2% PVA to 2% PE fibers, the moment capacity decreased by 33%. This reduction in the moment capacity of the FA40-SF10 mix aligns well with the values obtained from the ultimate tensile strength results presented in the direct tension test that could confirm the integrity of the conducted experiments. As previously explained, the lower first cracking strength of FA40-SF10 is distinct from other UDCs, which would influence its behavior.

### Scanning Electron Microscopy (SEM) Analysis

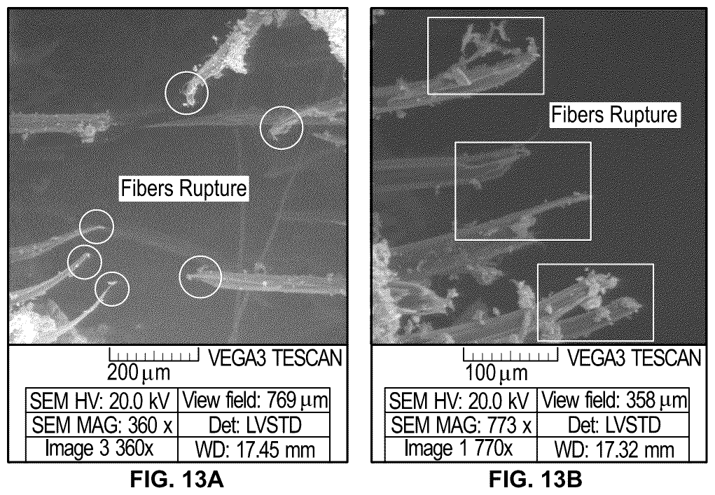

SEM analysis was done to identify the failure modes of the PVA fibers and PE fibers in UDC. The SEM micrographs are presented in FIG. 12 and FIG. 13. It can be observed in FIG. 12 that the failure mode in the case of PE fibers was mainly pullout failure with few of the ruptured fibers. This occurred because of a longer softening branch caused by a greater contribution from the fibers in crack bridging. Similar PE fibers failure modes were observed by several researchers.

However, as shown in FIG. 13, PVA fibers underwent a rupture failure instead of pulling out of the matrix. The fiber rupturing can increase the crack width by reducing the crack bridging capacity. Therefore, the lower tensile and flexural capacities of PVA-UDC compared to PE-UDC can be attributed to this phenomenon. Furthermore, the tensile strength of PE fibers (3000 Mpa) is almost 1.9 times of the PVA fibers (1600 Mpa), which is another possible cause for the lower tensile capacity of PVA-UDC.

The following conclusions can be drawn based on the above as to the various UDC compositions of the present invention:

S50 showed superior mechanical properties and performance at different fiber types (i.e., PVA vs. PE) and contents (i.e., 1.5% vs. 2%) among the four primary mixes in terms of strength and deflection under different load configurations. For 2% PVA and 2% PE fiber, the strain capacity of S50 is 1.34 and 1.4 times larger than F50, respectively.

Partially replacing 10% of FA in FA50 with MK (FA40-MK10) yielded improved mechanical performance, including higher tensile and compressive strength, bending moment capacity, and ductility for different fiber types (PVA vs. PE) and contents (1.5% vs. 2%). However, substituting FA with SF reduced the first cracking strength, ultimate tensile strength and bending moment capacity.

Increasing the PVA fiber quantity from 1.5% to 2% enhanced the compressive strength, ultimate tensile capacity, elongation, and bending moment of designed UDC mixes except FA50.

The results from the compressive strength test proved that a higher compressive strength with a higher fiber content is achievable by adopting appropriate approaches to improve fiber distribution, such as incorporating a rheology modifying agent (i.e., MC) to improve the fiber dispersion and the consistency of self-reinforced UDC mixes.

Substituting PE with PVA in mixes containing 2% fiber decreased the compressive strength in all UDC mixes due to the greater quantity of PE fibers in UDC mixes, rendering the PE mixes more vulnerable to increased porosity and strength reduction.

Replacing 2% PVA with 2% PE in UDC mixes enhanced the tensile strength, strain capacity, toughness, bending moment (except for FA40-SE10), fiber bridging, strain hardening and deflection of 3D-printed dogbone and beam specimens.

Based on SEM images of failed samples under direct tension test, UDC mixes reinforced with 2% PE fibers primarily exhibited pullout failures with a few ruptured fibers. In contrast, UDC mixes containing 2% PVA fibers displayed rupture failures. Hence, the lower tensile and flexural capacities of PVA-UDC compared to PE-UDC can be attributed to this phenomenon.

In addition to the mechanical properties of the chosen fibers for UDC, physical characteristics like the cross-sectional area and fiber length are crucial factors in determining their reinforcement capacity. UDC mixes reinforced with 8 mm PE fibers, which possessed 1.9 times greater tensile strength and ⅓ the diameter of 8 mm PVA fibers, resulted in an ultra-ductile fiber-reinforced 3D printable composite with superior mechanical and ductility performance. Thus, all specimens containing PE fibers exhibited a high ductility and can be considered ultra-high ductile UDC with strain capacity over 8%. For example, the S50-2% PE demonstrated superior strain hardening and toughness with 11.9% strain capacity.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A 3D-printable, self-reinforced ultra-ductile cementitious material comprising; a mix of 50 percent cement and 50 percent mineral admixture.

2. The 3D-printable, self-reinforced ultra-ductile cementitious material of claim 1 is reinforced with Polyethylene fibers.

3. The 3D-printable, self-reinforced ultra-ductile cementitious material of claim 1 is reinforced with 8 mm Polyethylene fibers.

4. The 3D-printable, self-reinforced ultra-ductile cementitious material of claim 3 wherein said 8 mm Polyethylene fibers are 2 percent volume of said mix.

5. The 3D-printable, self-reinforced ultra-ductile cementitious material of claim 3 wherein said 8 mm Polyethylene fibers are 1.5 percent volume of said mix.

6. The 3D-printable, self-reinforced ultra-ductile cementitious material of claim 3 wherein said admixture is slag.

7. The 3D-printable, self-reinforced ultra-ductile cementitious material of claim 4 wherein said admixture is fly ash.

8. The 3D-printable, self-reinforced ultra-ductile cementitious material of claim 4 wherein said admixture is metakaolin.

9. The 3D-printable, self-reinforced ultra-ductile cementitious material of claim 4 wherein said admixture is silica fume.

10. The 3D-printable, self-reinforced ultra-ductile cementitious material of claim 4 wherein said admixture is slag.

11. The 3D-printable, self-reinforced ultra-ductile cementitious material of claim 4 wherein said admixture is fly ash.

12. The 3D-printable, self-reinforced ultra-ductile cementitious material of claim 1 is reinforced with PolyVinyl Alcohol fibers.

13. The 3D-printable, self-reinforced ultra-ductile cementitious material of claim 12 wherein said PolyVinyl Alcohol fibers are 2 percent volume of said mix.

14. The 3D-printable, self-reinforced ultra-ductile cementitious material of claim 13 wherein said admixture is slag.

15. The 3D-printable, self-reinforced ultra-ductile cementitious material of claim 13 wherein said admixture is fly ash.

16. The 3D-printable, self-reinforced ultra-ductile cementitious material of claim 13 wherein said admixture is metakaolin.

17. The 3D-printable, self-reinforced ultra-ductile cementitious material of claim 13 wherein said admixture is silica fume.
